(19) United States
(12) Patent Application Publication
(10) Pub. No.: US 2025/0200456 A1
(43) Pub. Date: Jun. 19, 2025

(54) SYSTEMS AND METHODS FOR MAINTAINING AND UPDATING CALLER STATE IN A COMMUNICATION CENTER

(71) Applicant: Afiniti AI Limited, Dublin (IE)

(72) Inventors: Ain CHISHTY, Rockville, MD (US); Hassan AFZAL, Bethesda, MD (US)

(73) Assignee: Afiniti AI Limited, Dublin (IE)

(21) Appl. No.: 18/987,559

(22) Filed: Dec. 19, 2024

Related U.S. Application Data
(63) Continuation of application No. PCT/US2023/025877, filed on Jun. 21, 2023.
(60) Provisional application No. 63/354,581, filed on Jun. 22, 2022.

(51) Int. Cl. G06Q 10/0631; H04M 3/523

(52) U.S. Cl. CPC G06Q 10/0631; H04M 3/523

(57) ABSTRACT

There is provided a method in a call center system. The method comprises obtaining a script comprising a plurality of instructions for execution before a contact is paired to an agent at a contact center system, and obtaining a first plurality of contacts at a contact center. The method further comprises, for each contact, determining whether the contact has reached a predetermined threshold associated with any instruction in the obtained script; and if any one of the predetermined thresholds is reached, executing an associated instruction for the contact from the script.

### CROSS-REFERENCE TO RELATED APPLICATIONS

This application is a continuation of International Patent Application No. PCT/US2023/025877 filed on 2023 Jun. 21, which claims priority to U.S. Provisional Application No. 63/354,581, filed on 2022 Jun. 22. The above identified applications are incorporated by this reference.

### TECHNICAL FIELD

Disclosed are embodiments related to systems and methods for maintaining and updating caller state in a communication system.

### BACKGROUND

An example of a communication system is a contact center system. A contact center system may employ a pairing node that functions to assign contacts to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

### SUMMARY

Certain challenges presently exist. For instance, conventional contact center systems do not have enough capacity to handle many concurrent agents, nor do they have enough throughput to handle a high rate of incoming contacts. Consequently, conventional contact center systems typically require additional infrastructure such as load balancers to manage load across multiple systems (e.g., multiple automated call distributors or ACDs having groups of agents divided among them). Therefore, it is advantageous for a communication system, such as, for example, a contact center system, to manage computational resources including CPU, network bandwidth, and memory efficiently perform necessary operations as quickly as possible and reduce or eliminate the need for load balancers or other additional computational resources and infrastructure.

Accordingly, in one aspect there is provided a method in a call center system comprising: obtaining a script comprising a plurality of instructions for execution before a contact is paired to an agent at a contact center system; obtaining a first plurality of contacts at a contact center; for each contact, determining whether the contact has reached a predetermined threshold associated with any instruction in the obtained script; and if the predetermined threshold is reached, execute the associated instruction for the contact from the script.

Accordingly, in a second aspect there is provided a method in a call center system comprising: obtaining a script comprising a plurality of instructions for execution before a contact is paired to an agent at a contact center system; obtaining a first plurality of contacts at a contact center; determining whether each contact of the plurality of contacts has reached either a first predetermined threshold or a second predetermined threshold; executing a first instruction of the plurality of instructions for each contact of the plurality of contacts that has reached the first predetermined threshold; and executing a second instruction of the plurality of instructions for each contact of the plurality of contacts that has reached the second predetermined threshold.

Accordingly, in a third aspect there is provided a method in a contact center system comprising: at a first node, performing a first script executor; determining, at the first node, when the first script executor generates an action to be performed on one or more contacts; based on determining that the first script executor generated an action, (i) executing said action at the first node and (ii) syncing said action with a second, standby node; updating a memory state associated with said action at the second node; determining, at the second node, whether the first node had a failure event; based on determining that the first node did have a failure event, the second node becoming an active node for the contact center; performing, by the second node, a second script executor on contacts recorded in a memory of the second node.

Accordingly, in a fourth aspect there is provided a method in a contact center system comprising: obtaining, at a first node of a contact center system, a script comprising a plurality of instructions for execution before a contact is paired to an agent at a contact center system; obtaining, at the first node, a plurality of contacts at a contact center, wherein the plurality of contacts obtained by the first node were previously connected to a second node at of the contact center system, which second node was formerly an active node, and now has experienced a failure event; for each contact of the plurality of contacts, executing, by the first node an instruction of the obtained script associated with a status of the contact.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

### BRIEF DESCRIPTION OF THE DRAWINGS

The accompanying drawings, which are incorporated herein and form part of the specification, illustrate various embodiments.

FIG. 1A illustrates an example communication system according to an embodiment.

FIG. 1B illustrates an example communication system according to an embodiment.

FIG. 1C illustrates an example communication system according to an embodiment.

FIG. 1D illustrates an example communication system according to an embodiment.

FIG. 2 illustrates a pairing node of a contact center according to an embodiment.

FIG. 3 is a flowchart illustrating a process according to an embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a block diagram of a node according to an embodiment.

### DETAILED DESCRIPTION

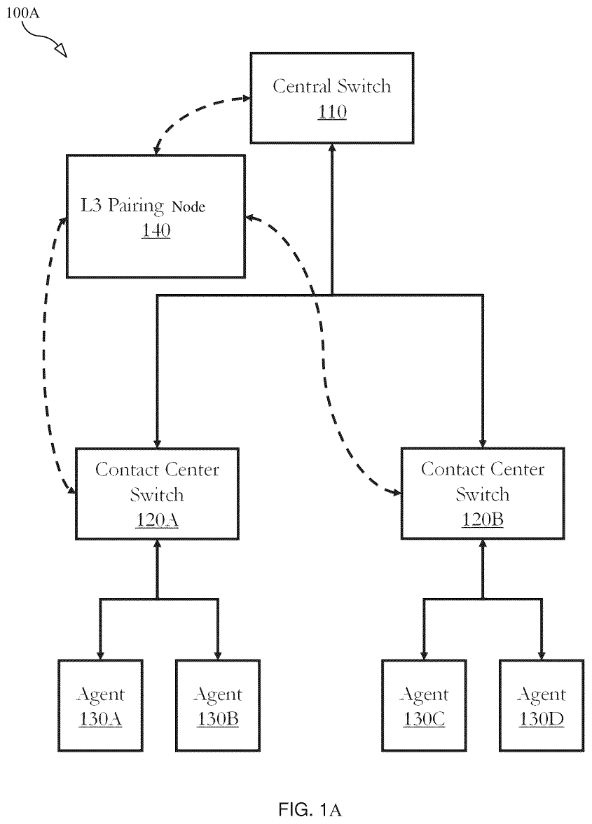

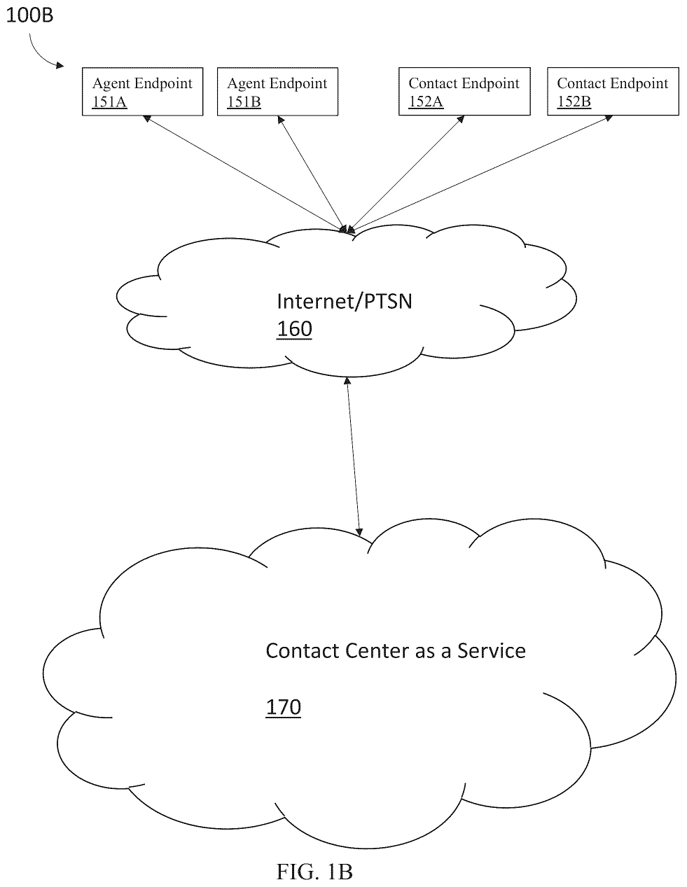

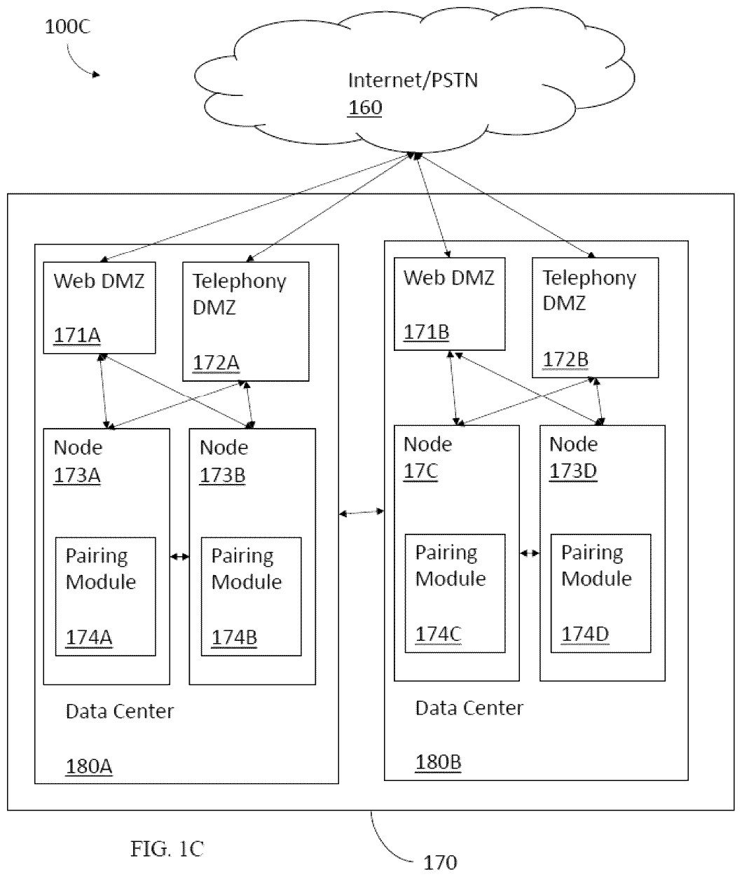

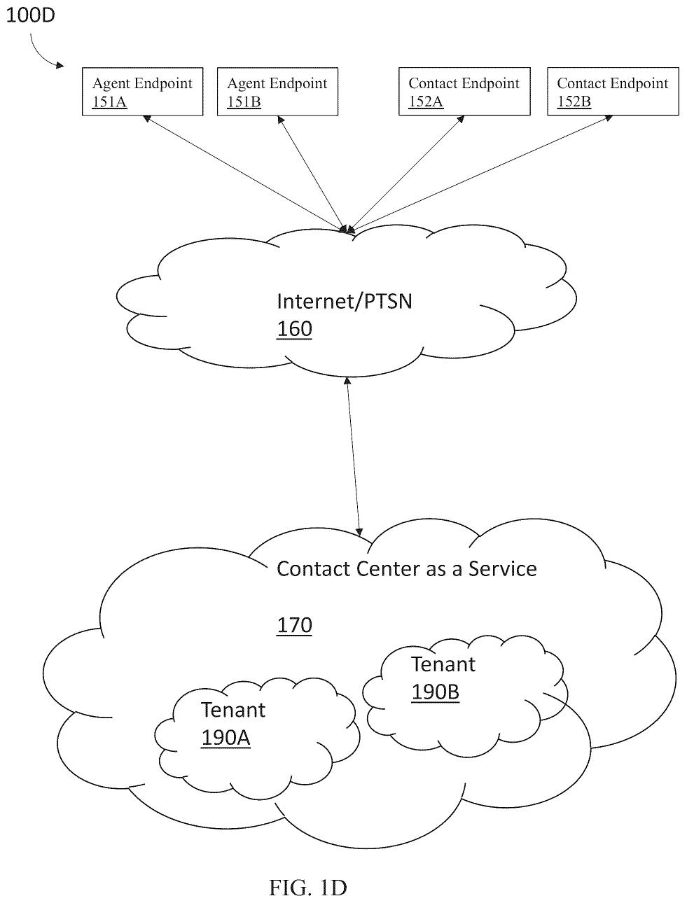

FIG. 1A illustrates an example communication system 100A. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing node 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing nodes. In some embodiments, pairing node 140 may be embedded within a component of a contact center system (e.g., embedded in or otherwise integrated with a switch). The pairing node 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing nodes. In some embodiments, one or more pairing nodes may be components of pairing node 140 or one or more switches such as central switch 110 or contact center switches 120A and 120B. In some embodiments, a pairing node may determine which pairing node may handle pairing for a particular contact. For example, the pairing node may alternate between enabling pairing via a Behavioral Pairing (BP) strategy and enabling pairing with a First-in-First-out (FIFO) strategy. In other embodiments, one pairing node (e.g., the BP pairing node) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment (DMZ) 171A and 171B, respectively, which is configured to receive the agent endpoints 151A, 151B and contact endpoints 152A, 152B, which are communicatively connecting to CCaaS via the Internet. DMZ equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CCaaS 170 is shown in FIG. 1D as comprising two tenants 190A and 190B. Turning back to FIG. 1C, for example, multi-tenancy may be supported by node 173A supporting tenant 190A while node 173B supports tenant 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine. In other embodiments, the system may be configured for multiple tenants on the premises of a business process outsourcer (BPO) or other service provider.

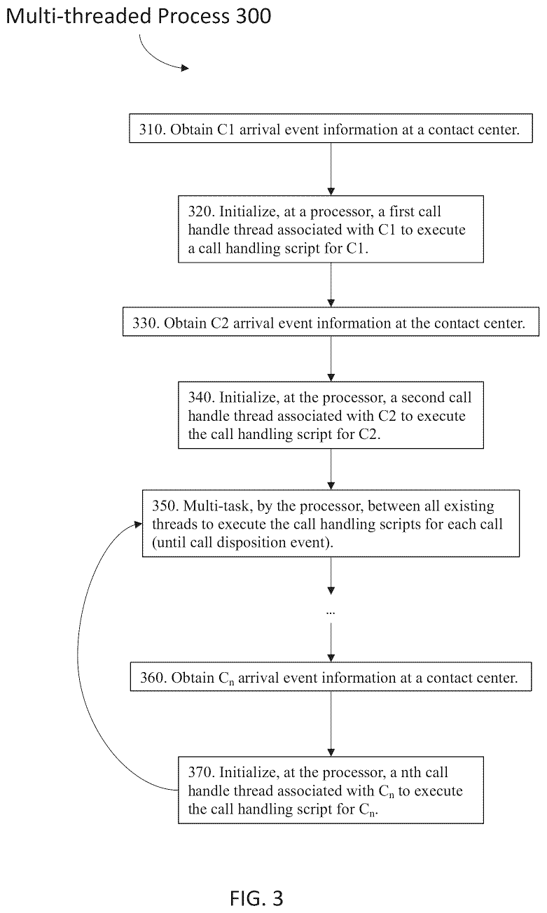

Contact centers often have several services operating within a computer node at any time, competing for processing power and bandwidth. Each service may have a private section of memory allocated to it, and these services conventionally pass objects, or information blocks, from service to service, through the kernel of a conventional operating system. This is a slow process due to the time constraints of (1) copying objects or other data through conventional data replication techniques, and (2) requiring additional processing power for kernel-based operations, such as running additional checks to protect each service's individual memory allocation and multitasking overhead. In some examples, as discussed below regarding FIG. 3, a single microservice might execute many separate processing threads through the kernel, where each processing thread may perform tasks for, or on, an object for said microservice. The kernel becomes more and more overburdened for larger contact center systems, quickly reaching capacity and/or throughput limits and creating other bottlenecks within the system. Contact centers receive hundreds, thousands, and hundreds of thousands of contacts; each of which contacts have a state associated with them, and which receive typically receive separate state updates per contact in a conventional contact center system. These separate updates create a great burden on the kernel, and increase the lag for tasks from each microservice. Accordingly, these processing threads create a limit on the capacity of conventional contact centers to handle more contacts and agents.

The present disclosure newly provides systems and methods for efficiently maintaining and updating caller state in a communication system, as discussed herein. The systems and methods discussed herein provide for a contact center with greatly increased capacity and throughput, operating with greater speed, efficiency, and bandwidth. The systems and methods of the present disclosure enable a contact center throughput of 100 or more calls per second, and capacity of over 100,000 concurrent callers and/or agents. The present disclosure also provides systems and methods for transitional call failover, as discussed herein. In a conventional contact center, when a switch or other component fails, both contacts and agents may be disconnected, including contacts waiting in a hold queue or speaking with an agent. The systems and methods of the present disclosure provide a contact center system able to maintain a high availability sync of transitional call state so that a script executor in a standby node may pick up right where the active node left off in the event of an active node failure, so that agents and callers are not disconnected.

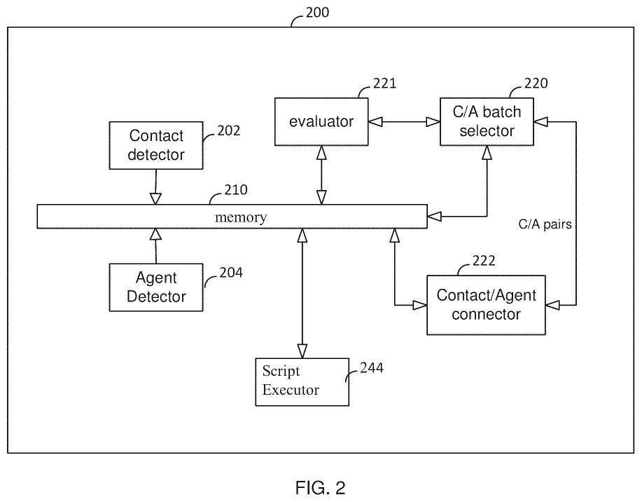

FIG. 2 illustrates an example pairing node 200 according to one embodiment (that is, for example, L3 pairing node 140 of FIG. 1A, or nodes 173A, 173B, 173C, 173D of FIG. 1B may be implemented using pairing node 200). In the embodiment shown, pairing node 200 includes physical memory 210 (e.g., random access memory RAM) such as dynamic RAM (DRAM) or static RAM (SRAM)) for storing contact center information that identifies: (i) a set of contact identifiers (IDs) associated with contacts available for pairing (i.e., contacts waiting to be connected to an agent) and (ii) a set of agent IDs associated with agents available for pairing. In some embodiments, the contact center information includes: i) for each contact ID, metadata for the contact associated with the contact ID (this metadata may include state information indicating whether the contact is available (i.e., waiting to be paired), a score assigned to the contact and/or information about the contact) and ii) for each agent ID, metadata for the agent associated with the agent ID (this metadata may include state information indicating whether the agent is available, a score assigned to the agent and/or information about the agent).

Exemplary information about the contacts and/or agents that may be stored in memory 210 and is associated with the contact ID or agent ID includes: attributes, arrival time, hold time or other duration data, estimated wait time, historical contact-agent interaction data, agent percentiles, contact percentiles, a state (e.g., ‘available’ when a contact or agent is waiting for a pairing, ‘abandoned’ when a contact disconnects from the contact center, ‘connected’ when a contact is connected to an agent or an agent is connected to a contact, ‘completed’ when a contact has completed an interaction with an agent, ‘unavailable’ when an agent disconnects from the contact center) and patterns associated with the agents and/or contacts.

Pairing node 200 also includes several modules (software and/or hardware components) (e.g., microservices) including a contact detector 202 and an agent detector 204. Contact detector 202 is operable to detect an available contact (e.g., contact detector 202 may be in communication with a switch that signals contact detector 202 whenever a new contact calls the contact center) and, in immediate response to detecting the available contact, store in memory 210 at least a contact ID associated with the detected contact (the metadata described above may also be stored in association with the contact ID). Similarly, agent detector 204 is operable to detect when an agent becomes available and, in immediate response to detecting the agent becoming available, store in memory 210 at least an agent identifier uniquely associated with the detected agent (metadata pertaining to the identified agent may also be stored in association with the agent ID). In this way, as soon as a contact/agent becomes available, memory 210 will be updated to include the corresponding contact/agent identifier and state information indicating that the contact/agent is available. Hence, at any given point in time, memory 210 will contain a set of zero or more contact identifiers where each is associated with a different contact waiting to be connected to an agent, and a set of zero or more agent identifiers where each is associated with a different available agent.

Pairing node 200 further includes other modules (e.g., microservices) including: (i) a contact/agent (C/A) batch selector 220 that functions to identify (e.g., based on the state information) sets of available contacts and agents for pairing, and provide state updates (i.e., modify the state information) for contacts and agents once the contacts and agents are selected for pairing; (ii) a C/A pairing evaluator 221 that functions to evaluate information associated with available contacts and information associated with available agents in order to propose contact-agent pairings; and (iii) a script executor 244 which may execute instructions associated with a state of each contact, according to the embodiments discussed further herein. As shown in FIG. 2, C/A batch selector 220 is in communication with memory 210, and, thereby, can read from memory 210 the contact center information stored therein (e.g., a set of contact IDs where each contact ID identifies an available contact and a set of agent IDs where each agent ID identifies an available agent). In one embodiment, C/A batch selector 220 is configured to occasionally (e.g., periodically) read memory 210 to obtain a list of available contacts and available agents based on a state associated with the agents and contacts listed in the memory 210. Further, the C/A batch selector 220 is in contact with a C/A pairing evaluator 221, and, after obtaining a list of available contacts and available agents, the C/A batch selector 220 may send the list to the C/A pairing evaluator 221 (e.g., sending contact IDs and agent IDs to the C/A pairing evaluator 221).

After the C/A pairing evaluator 221 receives a set of contact IDs and agent IDs from the C/A batch selector 220, the C/A pairing evaluator 221 may read from memory 210 further information about the received contact IDs and agent IDs. The C/A pairing evaluator 221 uses the read information in order to identify and propose agent-contact pairings for the received contact IDs and agent IDs based on a pairing strategy, which, depending on the pairing strategy used and the available contacts and agents, may result in no contact/agent pairings, a single contact/agent pairing, or a plurality of contact agent pairings.

Upon identifying contact/agent pairing(s), the C/A pairing evaluator 221 sends the set of contact/agent pairing(s) to the batch selector 220. The C/A batch selector 220 provides the set of contact/agent pairing(s) to a contact/agent connector 222 (e.g., if the contact associated with contact ID C12 is paired with the agent associated with the agent ID A7, then C/A batch selector 220 provides these contact/agent IDs to contact/agent connector 222). If the pairing process results in one or more contact/agent pairings, then, for each contact/agent pairing, C/A batch selector 220 will transmit an updated state associated with each contact ID and each agent ID in the one or more contact/agent pairings to memory 210, which is then associated with each contact ID and agent ID. Thereby, memory 210 retains the contact IDs and agent IDs for future analysis.

Contact/agent connector 222 functions to connect the identified agent with the paired identified contact. Further, C/A connector 222 transmits an updated state associated with each contact ID and each agent ID in the one or more contact/agent pairings to memory 210, which is then associated with each contact ID and agent ID.

Therefore, in one embodiment, pairing node 200 provides an asynchronous polling process where memory 210 provides a central repository that is read and updated by the contact detector 202, agent detector 204, script executor 244, C/A batch selector 220, C/A pairing evaluator 221, and C/A connector 222. Accordingly, the objects of each agent and contact do not need to be moved or copied among the microservices of pairing node 200; instead, identifiers associated with the objects are transmitted or shared among the contact detector 202, agent detector 204, memory 210, C/A batch selector 220, C/A pairing evaluator 221, and C/A connector 222, and the objects stay in place within memory 210, which is shared and accessible to each microservice without the need to rely on an operating system kernel to facilitate data copying among the microservices. This process conserves bandwidth, processing power, memory associated with each microservice, and is more expedient than conventional event-based pairing nodes.

FIG. 3 is a flowchart illustrating a multi-threaded process 300 for executing call handle scripts, according to an embodiment. Process 300 begins at step 310, by obtaining a first contact's arrival event information at a contact center. For example, the first contact is referred to herein as C1. In some examples, the first contact is received at contact detector 202 of node 200.

Step 320 comprises initializing, at a processor of the contact center, a first call handle thread associated with C1 to execute a call handling script for C1. For example, the call handling script is stored in a predefined configuration file of the node 200. For example, the call handle thread continues to execute the call handling script for C1 until there is a call disposition event for C1. Disposition events may include any of: a call is no longer connected to the contact center, a caller abandons and leaves the queue (either intentionally or unintentionally through call disrupts), a caller being connected to an agent, and/or a call is associated with a request for callback.

Step 330 comprises obtaining arrival event information of a second contact (e.g., C2) at the contact center.

Step 340 comprises initializing, at the processor of the contact center, a second call handle thread associated with C2 to execute a call handling script for C2. For example, the call handle thread continues to execute the call handling script for C2 until there is a call disposition event for C2. For example, the call handling script for C2 may be different than the call handling script for C1 (e.g., if C1 and C2 have a different priority, and/or a different call type) or may be the same (e.g., if C1 and C2 have the same priority, and/or the same call type).

Step 350 comprises multi-tasking, by the processor, between all existing threads to execute the call handling scripts for each call. This multi-tasking continues for all threads associated with calls that have not yet had a call disposition event.

Step 360 comprises obtaining arrival event information of a subsequent contact (e.g., Cₙ) at the contact center. For example, any number of contacts may arrive at the contact center during process 300.

Step 370 comprises initializing, at the processor, a nth call handle thread associated with Cₙ to execute the call handling script for Cₙ. That is, each call has a call handle script associated with the call. Process 300 then returns to step 350.

Altogether, process 300 provides a method for executing a call handling script for each call. However, process 300 provides a time-inefficient, and computational resource-intensive process. For example, the system suffers from overhead to multitask among threads for each caller. Further, process 300 has low fault tolerance if the node executing the call handling script for each call has a failure. Because process 300 requires many threads with many associated actions, process 300 requires many computational resources to synchronize a backup node with a state for each call, each associated thread, and each associated state update when a new instruction from said script is executed. If such a process 300 were used for a contact center, all calls—including (1) calls where agents are connected to contacts, and (2) calls that are on hold in a queue—are at a high risk of being disconnected when the active node goes offline, even if there were a standby node, because the backup of information in the multi-threaded process 300 would be too slow and too bandwidth-intensive to design a contact center to manage transitional or active call state.

Therefore, the present disclosure provides new, efficient systems and methods for executing a call handling script for calls in the contact center. The present disclosure contemplates that a call handling script may include a series of instructions, and a time for each instruction to be executed. This is shown, for example, in Table 1 below.

TABLE 1
Exemplary Call Handling Script Instruction Set

| Instruction Number | Time for Execution | Task |
|---|---|---|
| 1 | 5 seconds after | Initiate interactive |
| | call arrives | voice response (IVR) |
| 2 | 10 seconds after | Initiate |
| | initiating instruction 1 | hold music |
| 3 | 40 seconds after | Loop/replay |
| | initiating instruction 2 | hold music |
| 4 | After agent marks | Initiate customer |
| | call completed | survey |

As shown, the timing may be a length of time from a call event (e.g., 5 seconds from call arrival), a length of time from initiation of another instruction (e.g., instruction 2 may be executed 10 seconds after instruction 1 was initiated for a call) or may be triggered directly by a call event (e.g., after agent marks call completed).

Further, the present disclosure provides for a data structure (e.g., stored in memory 212 of node 200), where each call received at the contact center has an associated state. As shown in Table 2 below, the associated state of each call may be a time that said call started a particular instruction of the call handling script.

TABLE 2
Caller Object and Associated State

| Caller Object | |
|---|---|
| identifier/address | State |
| Object identifier of C1 | Started instruction 1 at time 1 |
| Object identifier of C2 | Started instruction 2 at time 2 |
| Object identifier of C3 | Started instruction 2 at time 3 |
| Object identifier of C4 | Started instruction 1 at time 4 |
| Object identifier of C5 | Started instruction 3 at time 5 |

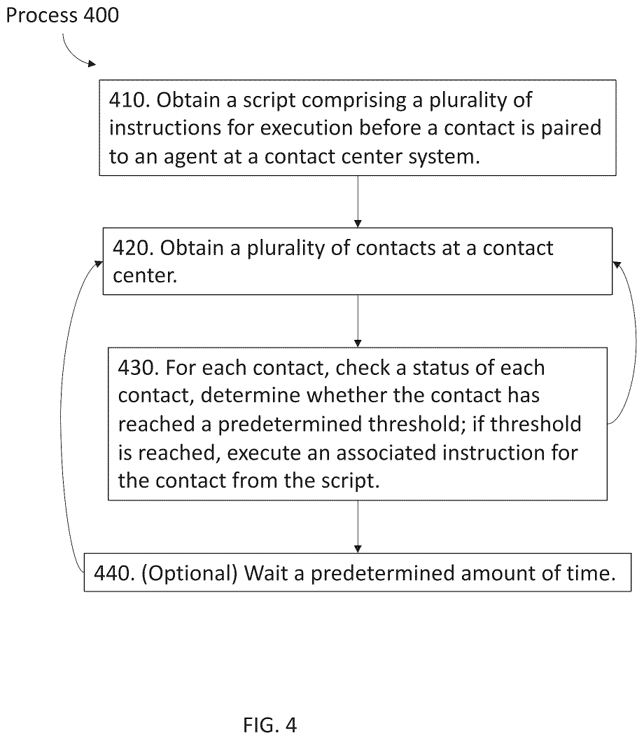

FIG. 4 is a flowchart illustrating a first single-threaded process 400 for executing call handle scripts according to an embodiment. For example, process 400 may use the data structures shown in Tables 1 and 2. Process 400 begins in step 410, which comprises obtaining a script comprising a plurality of instructions for execution before a contact is paired to an agent at a contact center system. For example, the script may include a plurality of instructions, wherein each instruction is associated with an identification (e.g., reference number or key), a time for execution (e.g., a predetermined threshold), and a task to be performed by the contact center for a call.

Step 420 comprises obtaining a first plurality of contacts at a contact center. For example, the first plurality of contacts may be contacts waiting on hold in one or more queues of the contact center, at time t=t₀. The plurality of contacts may be constantly updated, for example, by contact detector 202 of node 200. In some examples, the plurality of contacts may be stored as a linked list, where newly arriving contacts are added to the tail of the linked list (either as an object, or as an object identifier), and any call dispositions result in a removal of the object or in a removal of the object identifier of the caller from the linked list.

Step 430 comprises, for each contact, checking a status or state of each contact. Based on the status or state, step 430 further comprises determining whether the contact has reached a predetermined threshold associated with any instruction in the obtained script. For example, the predetermined threshold may be the “Time for Execution” column as shown in Table 1. If any one of the predetermined thresholds is reached, execute the associated instruction for the contact from the script. Therefore, contacts may be sequentially handled by process 400.

After completing step 430, process 400 may either proceed to step 440 or return to step 420. Following the latter pathway first, if process 400 returns directly to step 420, process 400 may obtain a second plurality of contacts at the contact center. For example, the second plurality of contacts may be contacts waiting on hold in one or more queues of the contact center, at time t=t₁, which time t=t₁ is after time t=t₀. Then step 430 may be performed for the second plurality of contacts. This process can cycle indefinitely, for as long as there are contacts at the contact center, and as long as the contact center is operational.

When process 400 proceeds to step 440, the method comprises waiting a predetermined amount of time before returning to step 420. Script execution for a plurality of calls according to the systems and methods of the present disclosure may occur faster than calls are arriving at the contact center, and therefore, the contact center may experience greater efficiency by waiting a predetermined amount of time before returning to step 420. By contrast, conventional methods for script execution are much slower than process 400, and must run continuously.

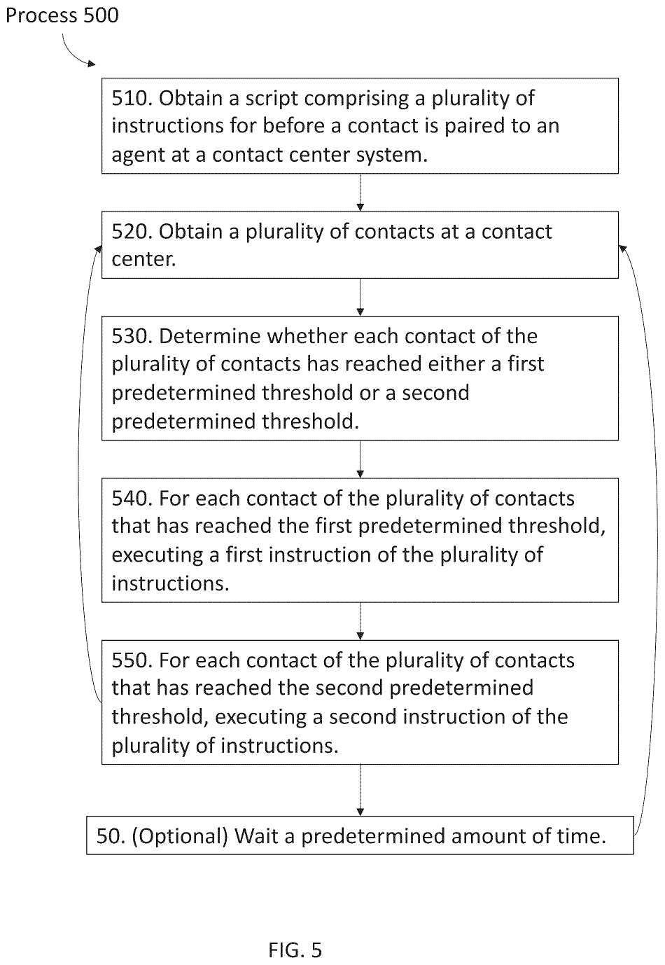

FIG. 5 is a flowchart illustrating a second single-threaded process 500 for executing call handle scripts according to an embodiment. FIG. 5 may be an alternative embodiment to the process disclosed above regarding FIG. 4. Process 500 begins in step 510, which comprises obtaining a script comprising a plurality of instructions for execution before a contact is paired to an agent at a contact center system. For example, step 510 may be as provided above regarding step 410.

Step 520 comprises obtaining a first plurality of contacts at a contact center. For example, step 520 may be as provided above regarding step 420.

Step 530 comprises determine whether each contact of the plurality of contacts has reached either a first predetermined threshold or a second predetermined threshold. In some examples, step 530 may check for a plurality of predetermined thresholds (e.g., the plurality of predetermined thresholds includes the first predetermined threshold, the second predetermined threshold, and additional thresholds). For example, step 530 may comprise cycling through a data structure similar to Table 2 as shown above, and identifying sets of contacts which are at, or have exceeded, the threshold for each instruction in the obtained script. That is, step 530 may obtain a first set of contacts which have met or exceeded the threshold for instruction 1, a second set of contacts which have met or exceeded the threshold for instruction 2, a third set of contacts which have met or exceeded the threshold for instruction 3, etc.

Step 540 may then comprise executing a first instruction of the plurality of instructions for each contact of the plurality of contacts that has reached the first predetermined threshold.

Step 550 may then comprise executing a second instruction of the plurality of instructions for each contact of the plurality of contacts that has reached the second predetermined threshold.

For example, steps 540 and 550 comprise executing the appropriate instruction for each set of contacts that has met a predetermined threshold associated with an instruction of the plurality of instructions (e.g., executing instruction 1 for the first set of contacts, executing instruction 2 for the second set of contacts, executing instruction 3 for the third set of contacts, etc.).

After completing step 550, process 500 may either proceed to step 560 or return to step 520. Following the latter pathway first, if process 500 returns directly to step 520, process 500 may obtain a second plurality of contacts at the contact center. For example, the second plurality of contacts may be contacts waiting on hold in one or more queues of the contact center, at time t=t₁, which time t=t₁ is after time t=t₀. Then steps 530-550 may be performed for the second plurality of contacts. This process can cycle indefinitely, for as long as there are contacts at the contact center, and as long as the contact center is operational.

When process 500 proceeds to step 560, the method comprises waiting a predetermined amount of time before returning to step 520 (e.g., 50 ms). Script execution for a plurality of calls according to the systems and methods of the present disclosure may occur faster than calls are arriving at the contact center, and therefore, the contact center may experience greater efficiency by waiting a predetermined amount of time before returning to step 520. By contrast, conventional methods for script execution are much slower than process 500, and must run continuously.

Therefore, processes 400 and 500 provide a single threaded process, where multiple calls can be handled sequentially (e.g., process 400) or in combination (process 500); either of which processes is faster than process 300 and conventional script handling processes. Processes 400 and 500 do not require the use of multiple threads, one thread being required for each call, which multiple threads compete against each other for execution by the processor. Rather, processes 400 and 500 use fewer computational resources (memory, bandwidth, processing power) than process 300. Additionally, processes 400 and 500 have higher fault tolerance when a primary, active node experiences a failure, because the processes 400 and 500 can be synchronized with a backup node with fewer computational resources than the requirements of process 300, as demonstrated in processes 600 and 700 below.

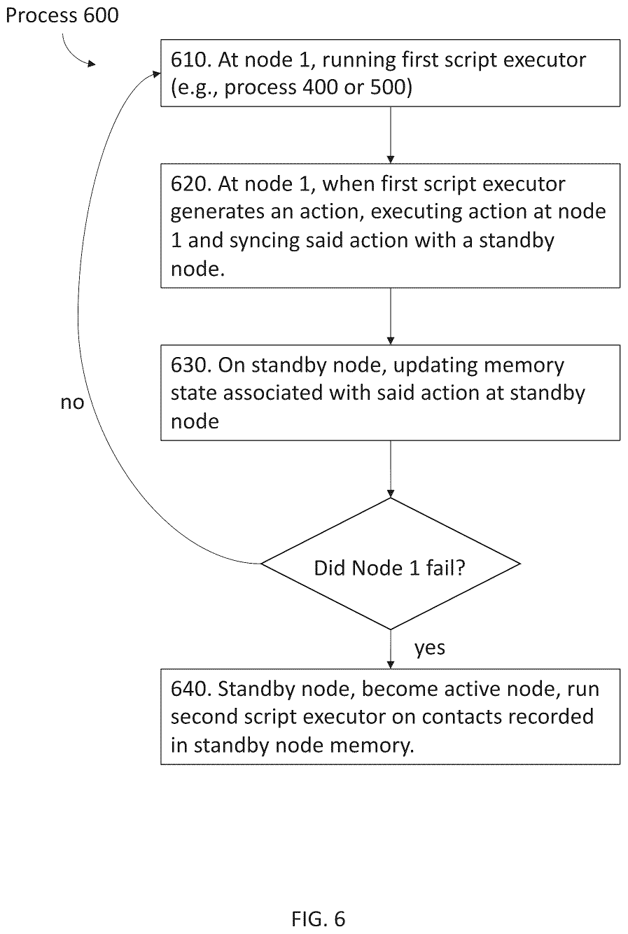

FIG. 6 is a flowchart illustrating a process 600 according to an embodiment. Process 600 begins at step 610, which comprises, at a first node (e.g., any of nodes 173A, 173B, 173C, or 173D), running a first script executor (e.g., performing process 400 or 500). Step 620 comprises, determining when the first script executor generates an action to be performed on one or more contacts. Based on determining that the first script executor generated an action, (1) executing said action at the first node and (2) syncing said action with a second, standby node (e.g., the standby node may be one or more remaining nodes of nodes 173A, 173B, 173C, or 173D). For example, the action can be synchronized through data replication or action synchronization. Step 630 comprises updating a memory state associated with said action at standby node. For example, the standby node may maintain a data structure which associates a Caller Object identifier/address with a state (e.g., Table 2 above). Step 640 comprises the second node determining whether the first node had a failure event. If the first node did not have a failure event, process 600 returns to step 610. If the first node did have a failure event, process 600 proceeds to step 640, which comprises the second, standby node becoming an active node. The second node then runs second script executor on contacts recorded in a memory of the second node. For example, the same data structure which was updated in step 630 may be used by step 640 for the second node to run a second script executor. For example, the second script executor may be either of processes 400 or 500.

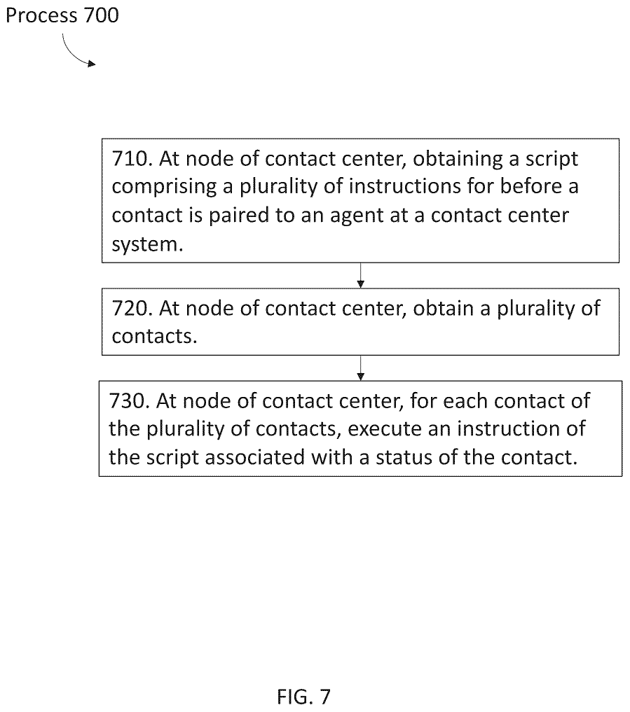

FIG. 7 is a flowchart illustrating a process 700 for a former backup/standby node to run a script executor as a new active node, once a former active node has had a failure event, according to an embodiment. Process 700 begins at step 710, which comprises obtaining, at a first node of a contact center system, a script comprising a plurality of instructions for execution before a contact is paired to an agent at a contact center system. For example, step 710 may be as provided above regarding steps 410 or 510. Step 720 comprises obtaining, at the first node, a plurality of contacts at a contact center. For example, step 520 may be as provided above regarding step 420. Further, the plurality of contacts obtained by the first node may all have been previously connected to a second node at of the contact center system, which second node was formerly an active node, and has experienced a failure event. Step 730 comprises for each contact of the plurality of contacts, executing an instruction of the obtained script associated with a status of the contact. For example, step 730 may correspond to processes 400 or 500.

Therefore, processes 600 and 700 may maintain transitional calls—contact endpoints which are being transitioned from “on hold” in a queue of the contact center to a connection with an agent endpoint—at the contact center. Processes 600 and 700 provide for a contact endpoint to be handled by a script executor via a new active node (e.g., node 173B if node 173A has a failure event), as handling was originally intended by a script executor of the former active node (e.g., node 173A); this maintenance of transitional calls is due to the backup node (e.g., node 173B) having data about the caller object identifier/addresses and associated states that is accurate to the time scale of recent microseconds or nanoseconds, and the instance of script executor now running on the new active node is stateless, processing the call object information previously synced to the new active node from the former active node prior to the failure event.

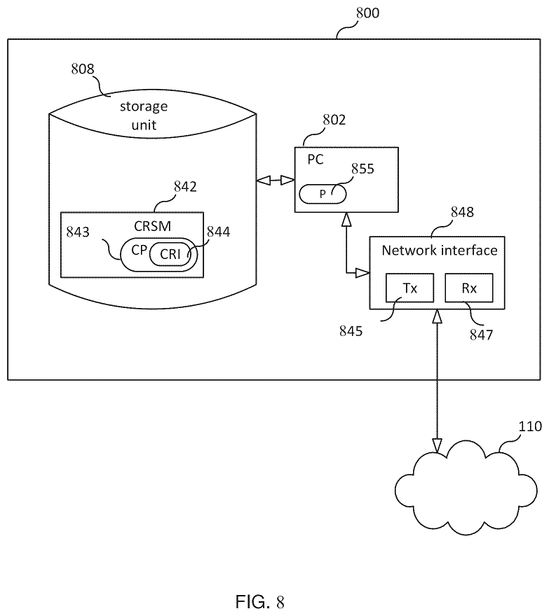

FIG. 8 is a block diagram of a node 800, according to some embodiments. Node 1000 can be an active node or a standby node. As shown in FIG. 8, node 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., node 800 may be a distributed computing apparatus); at least one network interface 849 (e.g., a physical interface or air interface) comprising a transmitter (Tx) 845 and a receiver (Rx) 847 for enabling node 800 to transmit data to and receive data from other nodes connected to a network 110 (e.g., an Internet Protocol (IP) network) to which network interface 849 is connected (physically or wirelessly) (e.g., network interface 849 may be coupled to an antenna arrangement comprising one or more antennas for enabling node 800 to wirelessly transmit/receive data); and a storage unit (a.k.a., “data storage system”) 809, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes node 800 to perform steps described herein (e.g., steps described herein with reference to the flow charts). In other embodiments, node 800 may be configured to perform steps described herein without the need for code. That is, for example, PC 802 may consist merely of one or more ASICs. Hence, the features of the embodiments described herein may be implemented in hardware and/or software.

### Summary of Various Embodiments

A1. A method in a call center system comprising: obtaining a script comprising a plurality of instructions for execution before a contact is paired to an agent at a contact center system; obtaining a first plurality of contacts at a contact center; for each contact, determining whether the contact has reached a predetermined threshold associated with any instruction in the obtained script; if any one of the predetermined thresholds is reached, execute an associated instruction for the contact from the script.

B1. A method in a call center system comprising: obtaining a script comprising a plurality of instructions for execution before a contact is paired to an agent at a contact center system; obtaining a first plurality of contacts at a contact center; determining whether each contact of the plurality of contacts has reached either a first predetermined threshold or a second predetermined threshold; executing a first instruction of the plurality of instructions for each contact of the plurality of contacts that has reached the first predetermined threshold; and executing a second instruction of the plurality of instructions for each contact of the plurality of contacts that has reached the second predetermined threshold.

C1. A method in a call center system comprising: at a first node, performing a first script executor; determining, at the first node, when the first script executor generates an action to be performed on one or more contacts; based on determining that the first script executor generated an action, (i) executing said action at the first node and (ii) syncing said action with a second, standby node; updating a memory state associated with said action at the second node; determining, at the second node, whether the first node had a failure event; based on determining that the first node did have a failure event, the second, standby node becoming an active node; performing, by the second node, second script executor on contacts recorded in a memory of the second node.

D1. A method in a call center system comprising: obtaining, at a first node of a contact center system, a script comprising a plurality of instructions for execution before a contact is paired to an agent at a contact center system; obtaining, at the first node, a plurality of contacts at a contact center, wherein the plurality of contacts obtained by the first node were previously connected to a second node at of the contact center system, which second node was formerly an active node, and has experienced a failure event; for each contact of the plurality of contacts, executing, by the second node an instruction of the obtained script associated with a status of the contact.

E1. A computer program (1043) comprising instructions (1044) which when executed by processing circuitry (1002) of a node causes the node to perform the method of any one of the above embodiments.

E2. A carrier containing the computer program of embodiment E1, wherein the carrier is one of an electronic signal, an optical signal, a radio signal, and a computer readable storage medium (1042).

F1. A node (1000) in a communication system, the node being configured to perform the method of any one of embodiments A1, B1, C1, or D1.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method in a call center system comprising:
obtaining a script comprising a plurality of instructions for execution before a contact seeking to communicate with an agent of a contact center is paired to an agent of the contact center, wherein
the plurality of instructions comprises a first instruction, and
the first instruction has a time for execution, where the time for execution of the first instruction is a point in time relative to the occurrence of a first event;
determining whether, for a first contact, the first event has occurred;
as a result of determining that the first event for the first contact has occurred, activating a first timer associated with the first contact;
after activating the first timer, using the first timer to determine whether the time for execution of the first instruction has arrived; and
as a result of determining that the time for execution of the first instruction has arrived, executing the first instruction.

2. The method of claim 1, wherein the method further comprises:
determining whether, for a second contact, the first event has occurred;
as a result of determining that the first event for the second contact has occurred, activating a second timer associated with the second contact;
after activating the second timer, using the second timer to determine whether a time for execution of the first instruction has arrived; and
as a result of determining that the time for execution of the first instruction has arrived using the second timer, executing the first instruction with respect to the second contact.

3. The method of claim 2, wherein a single process thread performs all of the recited steps.

4. The method of claim 1, wherein
the plurality of instructions further comprises a second instruction, and
the second instruction has a time for execution, where the time for execution of the second instruction is a point in time relative to an execution time of the first instruction.

5. The method of claim 4, wherein
the plurality of instructions further comprises a third instruction, and
the script indicates that the third instruction should be executed immediately after detecting the occurrence of a particular event.

6. The method of claim 1, wherein
the method further comprises storing in a memory a data structure comprising a set of records comprising a first record, and
the first record contains an identifier assigned to the first contact and state information indicating a state associated with the first contact.

7. The method of claim 6, wherein
the state information indicates a time at which the first instruction was executed with respect to the first contact.

8. The method of claim 7, wherein
the set of records further comprises a second record, and
the second record contains an identifier assigned to a second contact and state information indicating a state associated with the second contact.

9. The method of claim 8, wherein
the state information indicating the state associated with the second contact indicates a time at which the first instruction was executed with respect to the second contact.

10. A non-transitory computer readable storage medium storing a computer program comprising instructions for configuring a node comprising processing circuitry for executing the instructions to perform the method of claim 1.

11. A call center system being configured to:
obtain a script comprising a plurality of instructions for execution before a contact seeking to communicate with an agent of a contact center is paired to an agent of the contact center, wherein
the plurality of instructions comprises a first instruction, and
the first instruction has a time for execution, where the time for execution of the first instruction is a point in time relative to the occurrence of a first event associated with the contact;
determine whether the first event associated with the contact has occurred;
as a result of determining that the first event associated with the contact has occurred, activate a first timer;
after activating the first timer, use the first timer to determine whether the time for execution of the first instruction has arrived; and
as a result of determining that the time for execution of the first instruction has arrived, execute the first instruction.

12. The call center system of claim 11, wherein the method further comprises:
determining whether, for a second contact, the first event has occurred;
as a result of determining that the first event for the second contact has occurred, activating a second timer associated with the second contact;
after activating the second timer, using the second timer to determine whether a time for execution of the first instruction has arrived; and
as a result of determining that the time for execution of the first instruction has arrived using the second timer, executing the first instruction with respect to the second contact.

13. The call center system of claim 12, wherein a single process thread performs all of the recited steps.

14. The call center system of claim 11, wherein
the plurality of instructions further comprises a second instruction, and
the second instruction has a time for execution, where the time for execution of the second instruction is a point in time relative to an execution time of the first instruction.

15. The call center system of claim 14, wherein
the plurality of instructions further comprises a third instruction, and
the script indicates that the third instruction should be executed immediately after detecting the occurrence of a particular event.

16. The call center system of claim 11, wherein
the method further comprises storing in a memory a data structure comprising a set of records comprising a first record, and
the first record contains an identifier assigned to the first contact and state information indicating a state associated with the first contact.

17. The call center system of claim 16, wherein
the state information indicates a time at which the first instruction was executed with respect to the first contact.

18. The call center system of claim 17, wherein
the set of records further comprises a second record, and
the second record contains an identifier assigned to a second contact and state information indicating a state associated with the second contact.

19. The call center system of claim 18, wherein
the state information indicating the state associated with the second contact indicates a time at which the first instruction was executed with respect to the second contact.
